(19) United States
(12) Patent Application Publication
(10) Pub. No.: US 2011/0205760 A1
(43) Pub. Date: Aug. 25, 2011

(54) Modular solid-state illumination system for vending machines

(75) Inventor: Richard D. Ashoff, Newport Beach, CA (US)

(73) Assignee: Richard D. Ashoff

(21) Appl. No.: 12/929,828

(22) Filed: Feb. 18, 2011

Related U.S. Application Data
(60) Provisional application No. 61/282,486, filed on Feb. 19, 2010.

(51) Int. Cl. F21V 7/04

(52) U.S. Cl. 362/612

(57) ABSTRACT

A modular light emitting diode, edge-lit illuminating arrangement or a modular organic light emitting diode illuminating arrangement providing illumination. More particularly, a modular light emitting diode, edge-lit illuminating arrangement or a modular organic light emitting diode illuminating arrangement providing illumination for vending machines. The illuminating arrangements are adapted for backlighting in vending machines.

### CLAIM OF PRIORITY

This application is a non-provisional patent application claiming priority to U.S. Provisional Patent Application No. 61/282,486, filed on Feb. 19, 2010, which is incorporated herein by reference.

### TECHNICAL FIELD

The present invention pertains to the field of illumination and more particularly to backlighting of vending machines.

### BACKGROUND OF THE INVENTION

Vending machines such as machines used for vending soda, water and other beverages or snacks such as chewing gums, chocolate bars, potato chips and the like have panels on the face and/or sides of the machines for special effects and/or functional purposes such as advertising and/or relaying information. For example, a vending machine may have a large panel on the front that promotes a certain drink by a manufacturer or promote a product or its manufacturer and the like. These illuminated panels currently are being backlit with incandescent or fluorescent technology that consume high energy, are hot, have a relatively short life among other drawbacks such as containing mercury gas, in the case of fluorescent lamps. In comparison, the solid-state lighting technologies, that are the subject of the present invention, do not suffer from such short-comings.

In addition, the current fluorescent technology must be operated by high voltage ballasts that use excessive energy, are hot and cumbersome.

Further, the average lifespan of an incandescent lamp is only 2,000 to 5,000 hours requiring frequent lamp changes resulting in high maintenance cost. Conversely, the average lifespan of a fluorescent lamp is 8,000 to 20,000 hours, again, a relatively short time, compared to the average life of solid-state technology which is 30,000 to 50,000 hours and higher. The ballasts used for the fluorescent technology also have short life span, adding to the maintenance cost.

Fluorescent and incandescent technologies in the vending machines generate excessive heat that exits the machine housing adding heat to the environment and must to be removed. This excessive heat taxes the air conditioning equipment and adds to the total cost of operation.

Fluorescent technology has proven to be more efficient than incandescent technology and hereinafter all comparison of solid-state lighting is made to the fluorescent technology only.

It would be advantageous to have illumination systems using more efficient solid-state technology that are fully interchangeable with the existing fluorescent lamps.

For simplicity and clarity of illustration, the drawing figures illustrate the general manner of construction, and descriptions and details of well-known features and techniques may be omitted to avoid unnecessarily obscuring of the drawings. Additionally, elements in the drawing figures are not necessarily drawn to scale. For example, the dimensions of some of the elements in the figures may be exaggerated relative to other elements to help improve understanding of different illuminating arrangements. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the illuminating arrangements and methods for manufacturing the same described herein are, for example, capable of operation in sequences other than those illustrated or otherwise described herein.

Furthermore, the terms “include,” and “have,” and any variations thereof, are intended to cover a non-exclusive inclusion, such that a process, method, arrangement, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the illuminating arrangements and methods for manufacturing the same described herein are, for example, capable of operation in other orientations than those illustrated or otherwise described herein. The term “coupled,” as used herein, is defined as directly or indirectly connected in an electrical, physical, mechanical, optical, or other manner. The term “on,” as used herein, is defined as on, at, or otherwise adjacent to or next to or over. The terms “couple,” “coupled,” “couples,” “coupling,” and the like should be broadly understood and refer to connecting two or more elements, mechanically, electrically, optically, and/or otherwise, either directly or indirectly through intervening elements. Coupling may be for any length of time, e.g., permanent or semi-permanent or only for an instant. The absence of the word “removably,” “removable,” and the like near the word “coupled,” and the like does not mean that the coupling, etc. in question is or is not removable.

The term “translucent” describes a material that is translucent and/or partially transparent.

### DESCRIPTION OF THE DRAWINGS

FIG. 1 is a front elevation view of an LED, edge-lit illumination arrangement constructed in accordance with the present invention.

FIG. 2 is a perspective exploded view of the arrangement of FIG. 1.

FIG. 2a is a top view of an arrangement constructed in accordance with the present invention.

FIG. 2b is a top view of an arrangement constructed in accordance with the present invention.

FIG. 2c is a top view of an arrangement constructed in accordance with the present invention.

FIG. 2d is a top view of an arrangement constructed in accordance with the present invention.

FIG. 2e is a top view of an arrangement constructed of multiple arrangements to create a larger surface area in accordance with the present invention.

FIG. 2f is a top view of an arrangement constructed of multiple arrangements to create a larger and asymmetric surface area in accordance with the present invention.

FIG. 3 is a side view of the LEDs coupled to a lightguide of the arrangement of FIG. 1.

FIG. 4 is a front elevation view of an LED, edge-lit illumination panel assembly of LED light source used as edge lighting and v-cut planar lightguide panel;

FIG. 5 is a front elevation view of an LED, edge-lit illumination panel assembly of LED light source used as edge lighting and dot-printed planar lightguide panel;

FIG. 6 is a front elevation view of an LED, edge-lit illumination panel assembly of LED light source used as edge lighting and dot-etched planar light guide panel;

FIG. 7 is a front elevation view of an LED, edge-lit illumination panel assembly of LED light source used as edge lighting and microlenses, microprisms or microstructure planar light guide panel;

FIG. 8 is a schematic drawing of electrical circuitry of LEDs according to the present invention.

### DESCRIPTION OF THE PREFERRED ARRANGEMENT

The backlighting for the panels of vending machines can be replaced by light emitting diode, edge-lit panels or organic light emitting diodes according to the present invention. The backlighting arrangements of the present invention illuminate more evenly, use less energy than fluorescent lamps, do not require high voltage ballasts, contain no mercury gas, are cool and have a substantially longer life span and offer other advantages such as having a smaller physical form and a lower profile (e.g., avoiding hot stops and the need for diffusers and such) among other advantageous attributes.

The light emitting diode, edge-lit panels or organic light emitting diodes as light sources and herein referred to as light emitting panels (LEPs) can directly replace the existing fluorescent lamps used in backlighting of vending machines such as used in promoting a beverage such as Coca-Cola bottles or cans offered by the Coca-Cola Company of Atlanta, Ga., USA. The LEPs can be in sections arranged next to each other (e.g., in a planar manner), or otherwise, contiguously, to collectively and substantially have the same surface area or “mimic” one single panel that substantially has the same surface area as the surface being backlit. The panels being backlit are normally made out of a flat sheet of partially transparent or translucent glass or plastic sheets and/or plastic films that have markings, graphs, insignias, imprints, instructions, etc. to promote or convey information and the like as is well known in the art.

In one arrangement, an exemplary LEP comprises of a series of light emitting diodes (LEDs) arranged linearly on a circuit board and coupled to electric power, the LEDs adapted to project light into a flat lightguide through at least one edge of the lightguide. This type of arrangement is well-known in the art as edge-lighting. The lightguide may have a reflective surface on the back (i.e., white reflective paint), have light diverting members such as laser-etched grooves or printed dots formed on the upper surface of the lightguide to divert light, and an upper light diffusing member (i.e., diffusion film) to evenly distribute the light as is well known in the art. It is noted that although such an arrangement can be placed behind a panel and function according to the present invention; nonetheless, it is not the most preferred arrangement, as the arrangement is not protected from the environment and difficult to handle during installation and maintenance.

A more preferred arrangement encloses the above arrangement within an enclosure. This enclosure completely encases the above arrangement to protect the arrangement against the environment and make handling easier during installation and maintenance. The enclosure of the arrangement has an upper surface, a lower surface located substantially opposite the upper surface, and sides forming the perimeter around the edges of the upper and lower surfaces to form an enclosure. Hereinafter, LEP refers to an encased LEP according to the present invention.

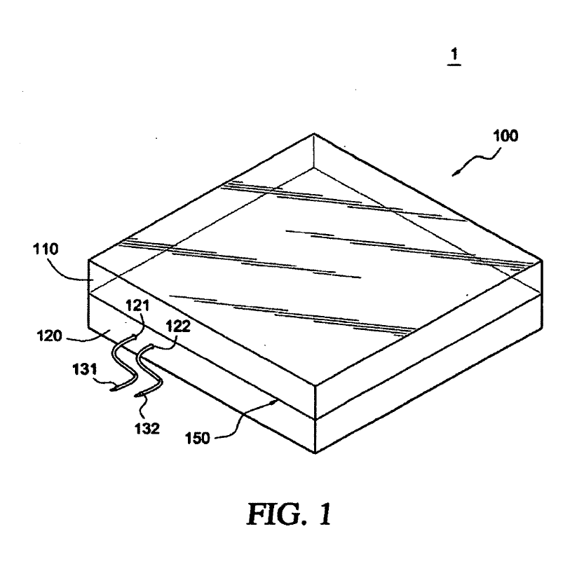

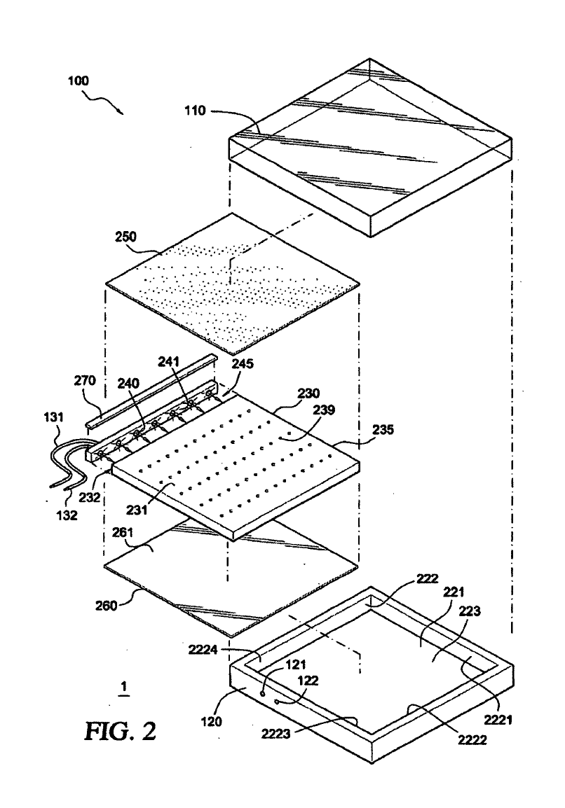

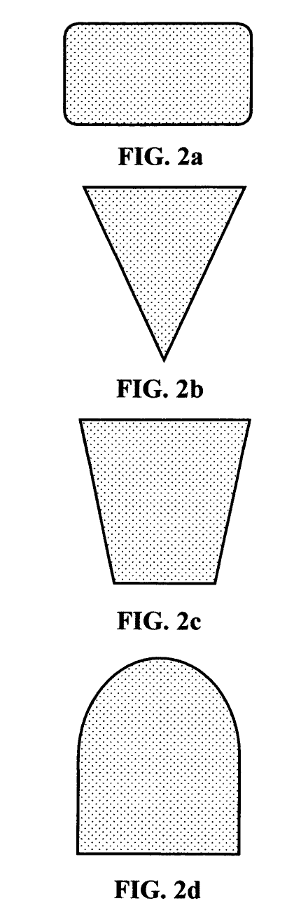

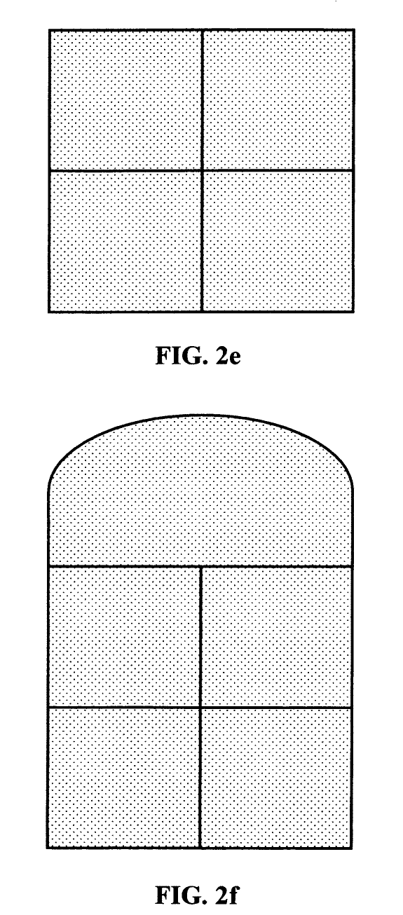

Referring now to the figures, FIG. 1 illustrates a perspective view of the preferred lighting of arrangement 1 comprising the LEDs 100. FIG. 2 illustrates a perspective exploded view of arrangement 1 with upper surface 110, lower surface 120 and coupled together at junction 150 (FIG. 1). As described in further detail below, LEP 1 comprises internal lighting that emits light visible through upper surface 110, where upper surface 110 is at least partially translucent. As a result, light emitting from the upper surface 110 of LEP 1 backlights a panel of a vending machine when turned on or otherwise energized. In the present example, upper surface 110 comprises a polymethyl methacrylate (PMMA) material such as HFI10100 from Atofina Chemicals, Inc. of Philadelphia, Pa., USA. Another example of upper surface 110 could use a PMMA material such as DF100, also from Atofina Chemicals, Inc. Although normally transparent, the PMMA material could also be pigmented if desired. In other examples, upper surface 110 can comprise a different plastic material, such as a polyester, polyamide, polycarbonate, high impact polystyrene, polyvinyl chloride (PVC), and/or acrylonitrile butadiene styrene (ABS), among others. Still other arrangements can comprise a glass material for upper surface 110.

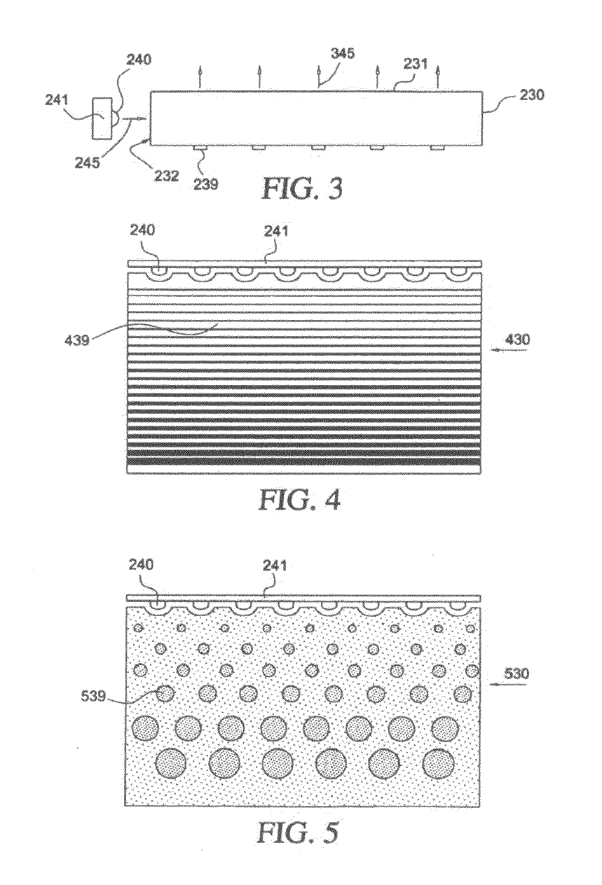

FIG. 2 illustrates a perspective exploded view of LEP 1 further comprising diffusive layer 250 located between sides 231 of lightguide 230 and upper surface 110. In the present example, diffusive layer 250 is configured to diffuse light directed towards upper surface 110. For example, diffusive layer 250 can be translucent, partially transparent, and/or frosted to diffuse portion 345 (FIG. 3) of light 245 evenly across upper surface 110. Other arrangements may eliminate the use of diffusive layer 250, particularly when lightguide 230 serves the same or similar function as diffusive layer 250.

LEP 1 also comprises reflective layer 260 in the present arrangement, where reflective layer 260 may comprise reflective sheet 261 located between lightguide 230 and inside surface 221 of lower surface 120. Reflective layer 260 can be configured to reflect at least a portion of light 245 that shines through side 232 of lightguide 230 back towards upper surface 110. In a different arrangement, reflective layer 260 can be eliminated, particularly where inside surface 221 serves the same function of reflective layer 260. Other examples may also forego the use of reflective layer 260. In yet another arrangement, reflective layer 260 can be eliminated, particularly where the back of lightguide 230 is, for instance, reflective paint on the back of lightguide 230.

Continuing with the arrangement of FIG. 2, arrangement 1 also comprises hot spot blocking mechanism 270 positioned between upper surface 100 and at least a portion of light sources or LEDs 240. Hot spot blocking mechanism 270 also can be located between diffusive layer 250 (when used) and carrier or circuit board 241. Hot spot blocking mechanism 270 is opaque, and can thus be used to block or diminish the appearance of “hot spots” or concentrations of light around the one or more light sources 240 in order to aid in the uniform distribution of light 245 towards upper surface 110. In the present example, hot spot blocking mechanism comprises a strip of metallic foil, although other materials such as an opaque plastic are also within the scope of the present invention. Other examples may forego the use of hot spot blocking mechanism 270.

It is understood that the upper and lower surfaces and the perimeter sides 222, 2221, 2222 and 2223 that in conjunction with the upper surface 110 and the surface 221 form an enclosure as shown. The perimeter sides 222, 2221, 2222 and 2223 are schematically shown in FIG. 2 to be an integral part of the lower surface 120, but these sides can be fabricated separately and attached later. However, in practice, it is preferred to form the upper or lower surface with perimeter sides integrated therein to minimize the number of parts and facilitate ease of manufacturing and handling. For instance, the perimeter sides can be integrated during molding process as is well known in the art. Further, it is understood that the LEPs are shown in essentially square form; but in practice, there are no limitations on the form (i.e., triangular, rectangular, elliptical or hexagonal. etc.) and asymmetrical forms can also be made according to the present invention. FIGS. 2a through 2d show the top view of some of the possible forms.

It is understood that the lower surface 120 and perimeter surfaces 222, 2221, 2222 and 2223 can also be made from the same materials as disclosed for upper surface 110 above, or of other materials as desired.

In addition to the different shapes shown in FIGS. 2a to 2d, it is noted that LEP sections can be positioned adjacent (e.g., contiguous arrangement) to each other to form any shape to adequately backlit the panels according to the present invention. For instance, four LEPs with substantially square shapes can be placed next to each other to form a larger square surface (FIG. 2e). Conversely, a half-circle or half-moon can be added to the four square section of FIG. 2e to form a surface shape as shown in FIG. 2f. It is also noted that by being able to position LEP sections in the manner described herein (e.g., in a modular and in a contiguous arrangement), the need to fabricate custom shapes for every vending machine is eliminated, resulting in substantial cost savings.

Light sources or LEDs 240 of the lighting arrangement 1 may be manufactured on a rigid or flexible circuit board 241 and designed in different formats as desired. FIG. 8 illustrates an electrical schematic of circuitry 800 for one or more LEDs 240 of LEP 1 (FIGS. 1-2). Circuitry 800 can comprise power supply circuit 810 to power at least a portion of one or more LEDs 240. In the present example, power supply circuit 810 couples to light sources 240 through leads 131-132 to supply rated power magnitude 820 of approximately 12 Volts DC (direct current). Although light sources 240 are rated to handle at least approximately 12 Volts DC in the present arrangement, other arrangements may comprise light sources (LEDs) configured to handle a different rated power magnitude, such as approximately 3 Volts DC or 24 Volts DC.

It is understood that, although series of LEDs in FIG. 2 are shown to project light into lightguide 230 only on one edge 232, if necessary to increase the intensity or for other illumination effects, to project light from more than one side as is well known in the art.

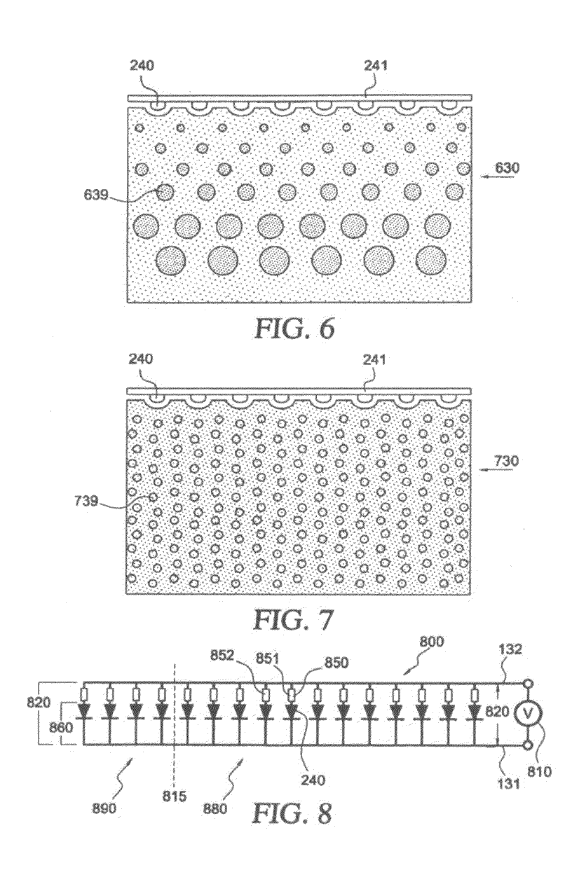

FIG. 3 illustrates a side view of lightguide 230 coupled to one or more LEDs 240 of arrangement 1. Lightguide 230 comprises features 239 configured to direct at least portion 345 of light 245 towards upper surface 110. In the present example, features 239 are substantially evenly distributed across lightguide 230 and can also shine portion 345 of light 245 in a substantially uniform pattern towards upper surface 110. In other arrangements, lightguide 230 can comprise features different from features 239 to direct light towards upper surface 110 (FIGS. 1 and 2) in a substantially uniform pattern. As an example, FIG. 4 illustrates a top view of lightguide 430 comprising v-cut lightguide features 439, and FIG. 5 illustrates a top view of substrate 530 comprising dot-printed lightguide features 539. As further examples, FIG. 6 illustrates a top view of lightguide 630 comprising dot-etched light guide features 639, and FIG. 7 illustrates a top view of lightguide 730 comprising microlens, microprism, and/or microstructure light guide features 739.

In some examples, the features of lightguide 230 of arrangement 1, such as features 239 (FIGS. 2 and 3), 439 (FIG. 4), 539 (FIG. 5), 639 (FIG. 6), and/or 739 (FIG. 7), can be capable of shining a portion of light 245 in a substantially uniform pattern towards upper surface 110 (FIGS. 1 and 2) even if the features themselves are not substantially evenly distributed across their respective lightguide or differ in size and/or concentration. In any event, because upper surface 110 is partially translucent, it can permit at least portion 345 of light 245 to shine through upper surface 110 (FIGS. 1 and 2) and to be visible from an exterior of arrangement 1.

As mentioned before, organic light emitting diodes (OLEDs) can be used as a light source in the present invention. In such instances, where OLEDs are used, the OLED can be placed within the upper surface 110 and lower surface 120, and accordingly there is no need to mount LEDs onto a circuit board like circuit board 241 (FIG. 2), or to align light sources with respect to an edge like edge 232 of lightguide 230 (FIGS. 2-3). The use of OLEDs in this manner also eliminates the need for hot spot blocking mechanism 270 (FIG. 2).

The present arrangements may comprise derating circuit 850 configured to deliver a derated power magnitude 860 to one or more LEDs 240, where derated power magnitude 860 is less than rated power magnitude 820. In the present example, derating circuit 850 comprises resistance elements coupled between a node of lead 132 and each of LEDs 240 to generate derated power magnitude 860. Each one or more LEDs 240 is thus coupled to a different one of the one or more resistance elements of derating circuit 850 in the present example. As an example, the one or more resistance elements can comprise resistors 851-852, but other resistance elements can be used. Resistance values for the resistance elements may be tailored depending on, for example, a target lifetime for LEDs 240, the output of power supply circuit 810, and/or on the type or brand of light sources 240. By providing light sources 240 with derated power magnitude 860, instead of rated power magnitude 820, the longevity of light sources 240 can be increased accordingly.

In some instances, it may be desirable to project a certain illumination (i.e., different color temperature, relatively higher color rendering index or infrared for night vision and such) to accentuate a graph or color of the panel being illuminated by the LEP. In such instances a mixture of white LEDs and other color LEDs such as red, orange or yellow among other colors may be used. In another variation, a colored film may be placed between the upper surface of surface 250 and the upper surface 110 of the enclosure to vary the color of light emanating from the LEP. In one instance, for example, a Lee Gel Roll HI Sodium R651 manufactured by Lee Filters of Burbank, Calif., USA was used to create a “high-pressure-sodium-illumination” look using LEDs with very high temperature light color (e.g., over 7,000 degree Kelvin) that otherwise looked very white and very pale. In some instances, red-green-blue (RGB) LEDs may be used to achieve the desired color as is well known in the art.

The arrangements of the present invention are intended to replace the existing lights in the vending machines. As such, the input power to the LEPs may need to be converted, for example, by a transformer that connects to the socket already existing in the machines. In one example, the transformer may connect to the fluorescent socket and convert the power from 110 VAC (socket output) to 12 VDC (LEP input).

Although the illuminating arrangements and methods for manufacturing the same have been described with reference to specific arrangements, various changes may be made without departing from the spirit or scope of the disclosure herein. Various examples of such changes have been given in the foregoing description. These and other modifications would not interfere with or depart from the concepts described herein.

Accordingly, the disclosure of arrangements of the illuminating arrangements and methods for manufacturing the same is intended to be illustrative of the scope of the application and is not intended to be limiting. It is intended that the scope of this application shall be limited only to the extent required by the appended claims. For example, it will be readily apparent that the illuminating arrangements and methods for manufacturing the same discussed herein may be implemented in a variety of arrangements, and that the foregoing discussion of certain of these arrangements does not necessarily represent a complete description of all possible arrangements. As a specific example, although FIGS. 1-2 show upper surface 110 arrangement 2 as devoid of any graphics, there may be examples where upper surface 110 comprise graphics and patterns that block and/or accentuate the markings on the panels of the vending machine. Therefore, the detailed description of the drawings, and the drawings themselves, disclose at least one preferred arrangement of the illuminating arrangements and methods for manufacturing the same, and may disclose alternative arrangements of the illuminating arrangements and methods for manufacturing the same.

All elements claimed in any particular claim are essential to the illuminating arrangement claimed in that particular claim. Consequently, replacement of one or more claimed elements constitutes reconstruction and not repair. Additionally, benefits, other advantages, and solutions to problems have been described with regard to specific arrangements. The benefits, advantages, solutions to problems, and any element or elements that may cause any benefit, advantage, or solution to occur or become more pronounced, however, are not to be construed as critical, required, or essential features or elements of any or all of the claims.

Moreover, arrangements and limitations disclosed herein are not dedicated to the public under the doctrine of dedication if the arrangements and/or limitations: (1) are not expressly claimed in the claims; and (2) are or are potentially equivalents of express elements and/or limitations in the claims under the doctrine of equivalents.

1. A backlighting arrangement for vending machines, comprising:
at least one organic light emitting diode as a light source;
the at least one organic light emitting diode enclosed within an enclosure; and
the enclosure placed behind at least one panel of a vending machine to backlight the at least one panel of the gaming machine or a portion thereof.

2. The backlighting arrangement of claim 1 adapted to replace the existing fluorescent lamp(s) used for backlighting the one panel of the vending machine.

3. The backlighting arrangement of claim 1 where more than one module is used for backlighting the one panel of the gaming machine.

4. The backlighting arrangement of claim 1 where a light emitting diode, edge-lit panel is used as a light source instead of organic light emitting diode.

5. The backlighting arrangement of claim 4 adapted to replace the existing fluorescent lamp(s) used for backlighting the one panel of the vending machine.

6. The backlighting arrangement of claim 4 where more than one module is used for backlighting the one panel of the vending machine.
